(19) United States
(12) Patent Application Publication
(10) Pub. No.: US 2014/0295687 A1
(43) Pub. Date: Oct. 2, 2014

(54) SYSTEM HAVING AN AUXILIARY FITTING JIG

(71) Applicant: YAZAKI CORPORATION, Minato-ku (JP)

(72) Inventors: Daisuke SHINKAWA, Makinohara-shi (JP); Akihiro TSURUTA, Fujieda-shi (JP)

(73) Assignee: YAZAKI CORPORATION, Minato-ku (JP)

(21) Appl. No.: 14/285,342

(22) Filed: May 22, 2014

Related U.S. Application Data
(62) Division of application No. 13/574,038, filed on Jul. 19, 2012.

(30) Foreign Application Priority Data
Jan. 22, 2010 (JP) 2010-012312

(51) Int. Cl. H01R 13/629; H01R 13/639

(52) U.S. Cl. CPC H01R 13/62955; H01R 13/639
USPC 439/261

(57) ABSTRACT

Disclosed is a system including: a female connector; a male connector; and an auxiliary fitting jig which fits the female connector and the male connector to each other, including: a jig hooking section which includes a jig locking section which is engaged with one of the female and male connectors and a jig pushing section which is engaged with the other of the female and male connectors; and a jig gripping section which is integrally formed with the jig hooking section, rotates the jig pushing section by rotating the jig hooking section using the jig locking section as a supporting point, and fits the other connector to the one connector

### CROSS-REFERENCE TO RELATED APPLICATIONS

The present application is a divisional of U.S. application Ser. No. 13/574,038 filed Jul. 19, 2012, which is a National Stage of International Application No. PCT/JP2011/050773 filed Jan. 18, 2011, which claims priority from Japanese Patent Application No. 2010-012312 filed Jan. 22, 2010, the contents of all of which are incorporated herein by reference in their entirety.

### TECHNICAL FIELD

The present invention relates to an auxiliary fitting jig and a connector using the same in which the connector is fitted using the auxiliary fitting jig.

### BACKGROUND ART

In the related art, in order to fit a male housing and a female housing to each other, a lever type connector as disclosed in JP-A-2002-359028 (PTL 1) has been proposed, for example. In this lever type connector, the female and male housings are fitted to each other using leverage in which a lever is rotated using one side thereof as a supporting point, which can achieve reliability of the fitting operation.

As shown FIGS. 19 to 22, a lever type connector 100 includes a male housing 113, a lever 115 which is connected to the male housing 113 between one side and the other side thereof in a length direction thereof to be able to rotate, a connecting section 117 which connects the lever 115 to the male housing 113, and a female housing 119 which accommodates the male housing 113 to be fitted therein.

In this lever type connector 100, the connecting section 117 is configured in such a manner that protrusion sections 133 and 133 are respectively engaged with engaging holes 123 and 123, and the lever 115 is connected to the male housing 113 between one side and the other side thereof and is rotated using the protrusion sections 133 and 133 as an axis.

Further, when the male housing 113 and the female housing 119 are fitted to each other, engaging protrusions 125 and 125 of the lever 115 are engaged with engaging steps 129 and 129 of engaging grooves 131 and 131 of the female housing 119 to serve as supporting points. Further, an operating section 120 of the lever 115 is pushed in a downward direction which is a front end side of a direction where the male housing 113 and the female housing 119 are fitted to each other, and is rotated.

At this time, the male housing 113 generally moves downward by being directly pushed by a force applied to the protrusion sections 133 and 133 provided in the male housing 113 due to the leverage of the rotated lever 115 and the pushing force which pushes the operating section 120. As a result, the male housing 113 is fitted into a hood section 127 of the female housing 119.

### CITATION LIST

### Patent Literature

[PTL 1] JP-A-2002-359028

### SUMMARY OF INVENTION

### Technical Problem

However, in the above-described lever type connector 100 in the related art, since the male and female housings 113 and 119 are fitted to each other as the lever 115 is engaged with the female housing 119 to serve as the supporting point and is pushed downward to be rotated, a plurality of components, for example, for locking the lever 115 is necessary, which complicates a component management process to increase manufacturing cost.

Further, in the lever type connector 100 in the related art, since the male and female housings 113 and 119 are fitted to each other as the lever 115 is rotated, if the male and female housings 113 and 119 are once fitted to each other, the lever 115 is not used anymore while being mounted to the lever type connector 100, which increases the weight of components.

Accordingly, an object of the invention is to provide an auxiliary fitting jig and a connector using the same in which the number and weight of components can be decreased and manufacturing cost can be reduced.

### Solution to Problem

According to a first aspect of the invention, there is provided an auxiliary fitting jig which fits a female connector and a male connector to each other, including: a jig hooking section which includes a jig locking section which is engaged with one of the female and male connectors and a jig pushing section which is engaged with the other of the female and male connectors; and a jig gripping section which is integrally formed with the jig hooking section, rotates the jig pushing section by rotating the jig hooking section using the jig locking section as a supporting point, and fits the other connector to the one connector.

According to a second aspect of the invention, the jig locking section is a supporting point engaging section of a notch shape which is engaged with a supporting point protrusion of the one connector, and the jig pushing section is an action point engaging section which is engaged with an action point protrusion of the other connector.

According to a third aspect of the invention, the jig hooking section includes a jig extracting section which is engaged with one of the female and male connectors in a fitted state and extracts the one connector from the other connector by rotating the jig hooking section in a reverse direction compared with the time when the female and male connectors are fitted to each other using the jig locking section as the supporting point.

According to a fourth aspect of the invention, the action point protrusion, a temporary female locking protrusion which protrudes on the outside of the female connector and locks the female connector when being inserted into the male connector and a temporary female locking stopper which protrudes on the outside of the female connector and retains the female connector in a temporary locking position are provided in the female connector; and the supporting point protrusion, a temporary male locking protrusion which protrudes on the inside of the male connector and is overridden by the temporary female locking protrusion when the female connector is inserted and a temporary male locking stopper which protrudes on the inside of the male connector and retains the female and male connectors in the temporary locking position by being in contact with the temporary female locking stopper are provided in the male connector.

### Advantageous Effects of Invention

According to the first aspect of the invention, the auxiliary fitting jig which fits the female and male connectors to each other, includes: the jig hooking section which includes the jig locking section which is engaged with one of the female and male connectors and the jig pushing section which is engaged with the other of the female and male connectors; and the jig gripping section which is integrally formed with the jig hooking section, rotates the jig pushing section by rotating the jig hooking section using the jig locking section as the supporting point, and fits the other connector to the one connector. Thus, by removing the auxiliary fitting jig after the female and male connectors are fitted to each other, it is possible to decrease the weight of components of the connectors.

Further, since the auxiliary fitting jig is removed after the female and male connectors are fitted to each other, it is possible to remove components for locking the auxiliary fitting jig after fitting.

Accordingly, it is possible to provide an auxiliary fitting jig and a connector using the same in which the number and weight of components can be decreased and its manufacturing cost can be reduced compared with the lever type connector in the related art in which the lever is mounted as it is after the female and male connectors are fitted to each other.

According to the second aspect of the invention, the jig locking section is the supporting point engaging section of the notch shape which is engaged with the supporting point protrusion of the one connector, and the jig pushing section is the action point engaging section which is engaged with the action point protrusion of the other connector. Thus, if the diameter of the supporting point protrusion of the one connector is constant, the diameter of the action point protrusion of the other connector is constant, and the interval between the supporting point protrusion of the connector and the action point protrusion of the other connector is constant, even in a case where the female and male connectors are different, it is possible to fit the female and male connectors to each other using the same auxiliary fitting jig. Accordingly, it is possible to fit connectors of a plurality of sizes to each other using an auxiliary fitting jig of one type, to thereby provide an auxiliary fitting jig with high general usage and a connector using the same.

According to third aspect of the invention, the jig hooking section includes the jig extracting section which is engaged with one of the female and male connectors in the fitted state and extracts the one connector from the other connector by rotating the jig hooking section in the reverse direction compared with the time when the female and male connectors are fitted to each other using the jig locking section as the supporting point. Thus, it is possible to fit connectors to each other and separate the connectors from each other using an auxiliary fitting jig of one type. Further, since it is not necessary to manufacture an auxiliary fitting jig for fitting and an auxiliary fitting jig for separation, it is possible to reduce its cost.

According to the fourth aspect of the invention, as the temporary female locking stopper which protrudes on the outside of the female connector and the temporary male locking stopper which protrudes on the inside of the male connector are in contact with each other, the male connector and the female connector are retained in the temporary locking position. Thus, it is easy to mount the auxiliary fitting jig, and it is possible to easily fit the male connector and the female connector to each other.

### BRIEF DESCRIPTION OF DRAWINGS

FIG. 1A is an exploded perspective view illustrating an auxiliary fitting jig and a connector according to a first embodiment of the invention, and FIG. 1B is a perspective view illustrating the connector according to the first embodiment.

FIG. 2 is a side view illustrating the auxiliary fitting jig according to the first embodiment of the invention.

FIG. 3 is a diagram illustrating a temporary locking state of female and male connectors according to the first embodiment of the invention.

FIG. 4 is a diagram illustrating a state where the auxiliary fitting jig is mounted on the female and male connectors according to the first embodiment of the invention.

FIG. 5 is a diagram illustrating a process where the female and male connectors according to the first embodiment of the invention are fitted to each other.

FIG. 6 is a diagram illustrating a state where the auxiliary fitting jig according to the first embodiment of the invention is rotated.

FIG. 7 is a diagram illustrating a state where the female and male connectors according to the first embodiment of the invention are fitted to each other.

FIG. 8 is a diagram illustrating a state where the auxiliary fitting jig according to the first embodiment of the invention is detached.

FIG. 9 is a side view illustrating the female and male connectors according to the first embodiment of the invention.

FIG. 10 is a cross-sectional view taken along line A-A in FIG. 9.

FIG. 11 is a cross-sectional view taken along line B-B in FIG. 9.

FIG. 12 is a diagram illustrating general usage of the auxiliary fitting jig according to the first embodiment of the invention.

FIG. 13 is a diagram illustrating general usage of the auxiliary fitting jig according to the first embodiment of the invention.

FIG. 14 is a diagram illustrating general usage of the auxiliary fitting jig according to the first embodiment of the invention.

FIG. 15 is a diagram illustrating effects of the female and male connectors using the auxiliary fitting jig according to the first embodiment of the invention.

FIG. 16 is a perspective view illustrating an auxiliary fitting jig and a connector according to a second embodiment of the invention.

FIG. 17 is a side view illustrating an auxiliary fitting jig according to a third embodiment of the invention.

FIGS. 18A to 18F are diagrams illustrating fitting and detaching operations of connectors according to the third embodiment of the invention.

FIG. 19 is a perspective view illustrating a lever type connector in the related art.

FIG. 20 is a side view illustrating the lever type connector in the related art.

FIG. 21 is a side view illustrating the lever type connector in the related art.

FIG. 22 is a cross-sectional view when a male housing of the lever type connector in the related art is fitted into a female housing thereof.

### DESCRIPTION OF EMBODIMENTS

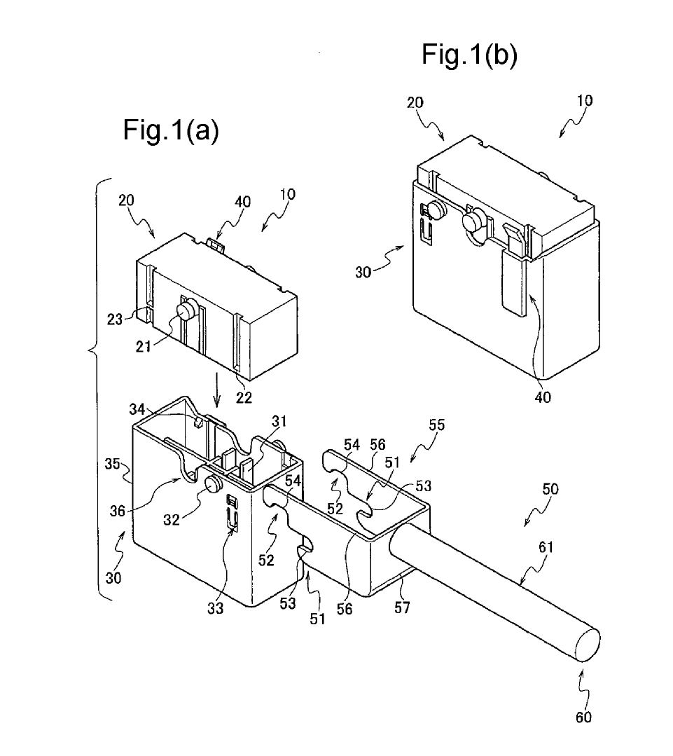

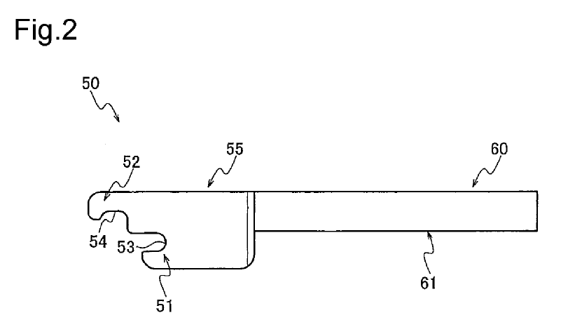

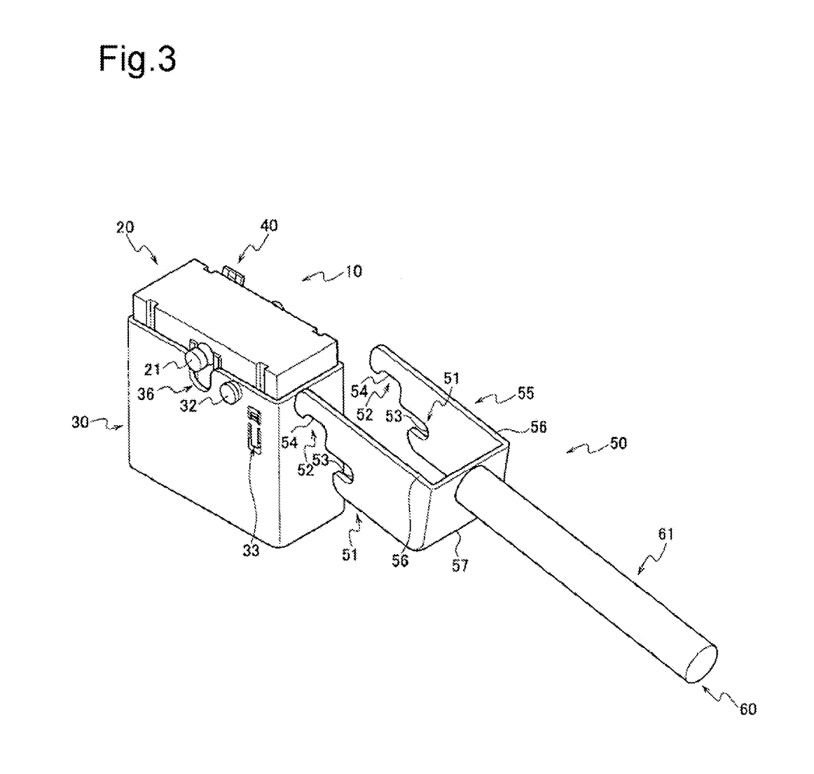

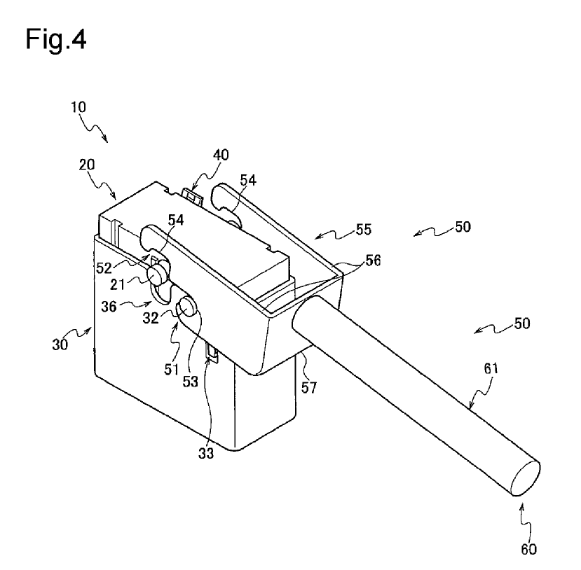

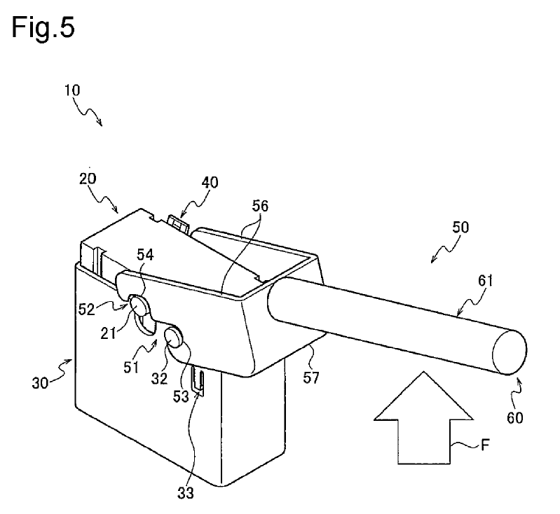

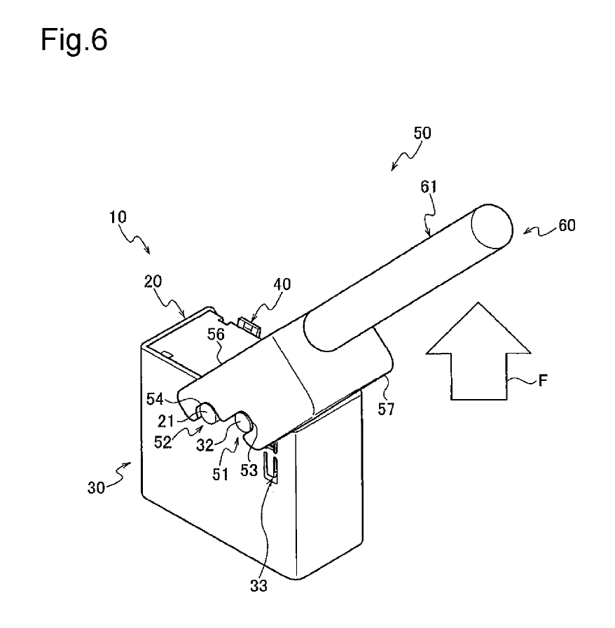

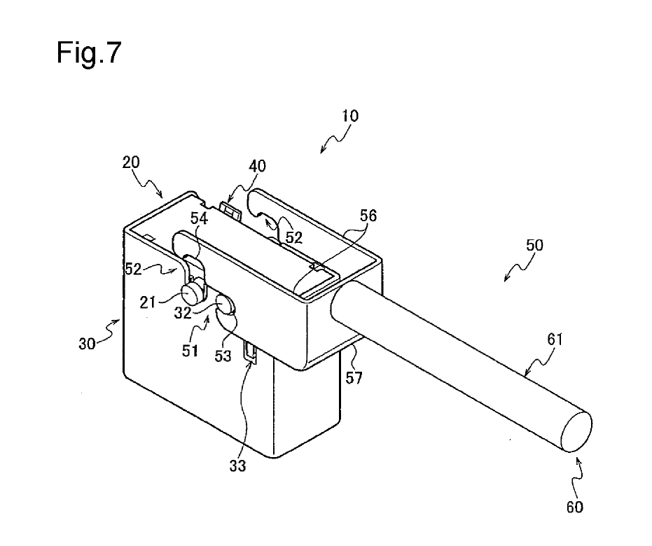

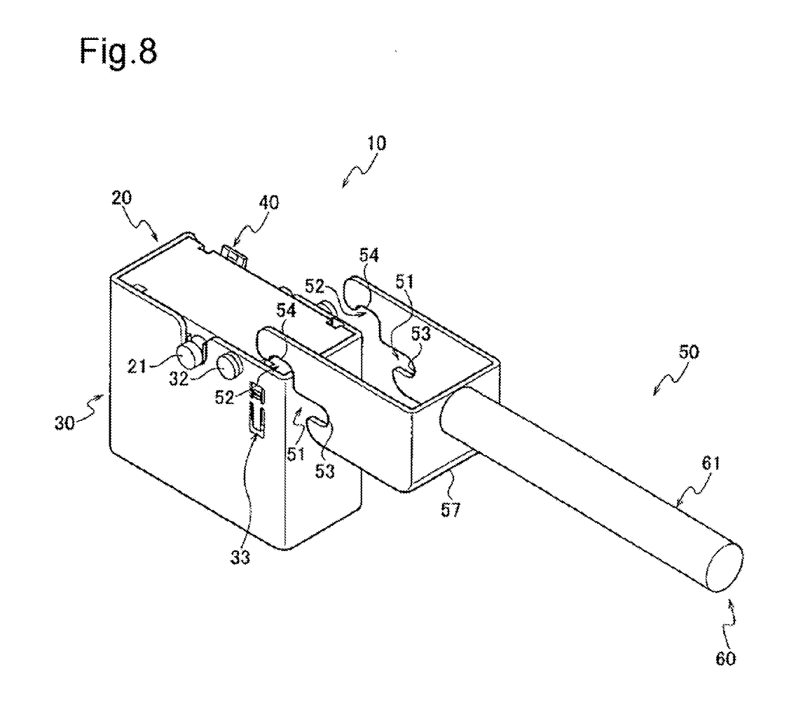

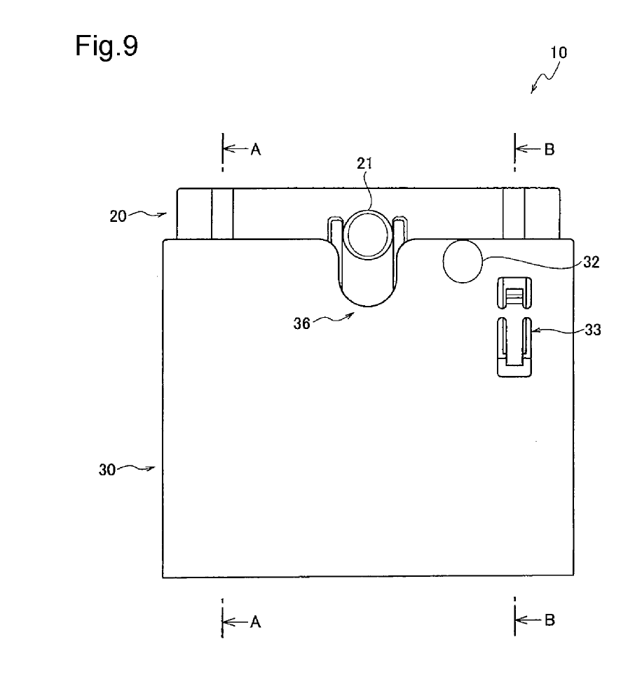

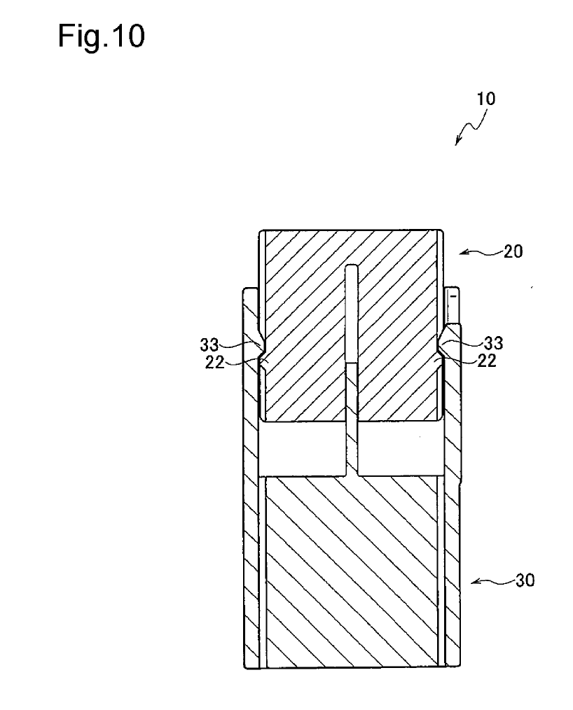

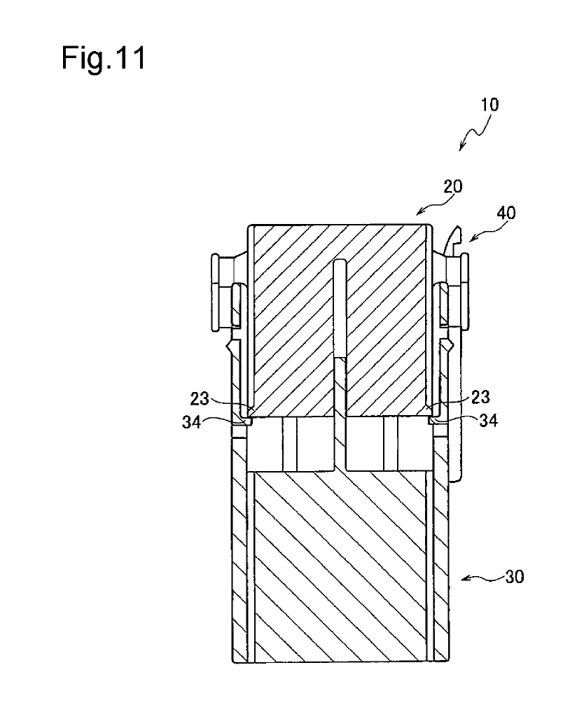

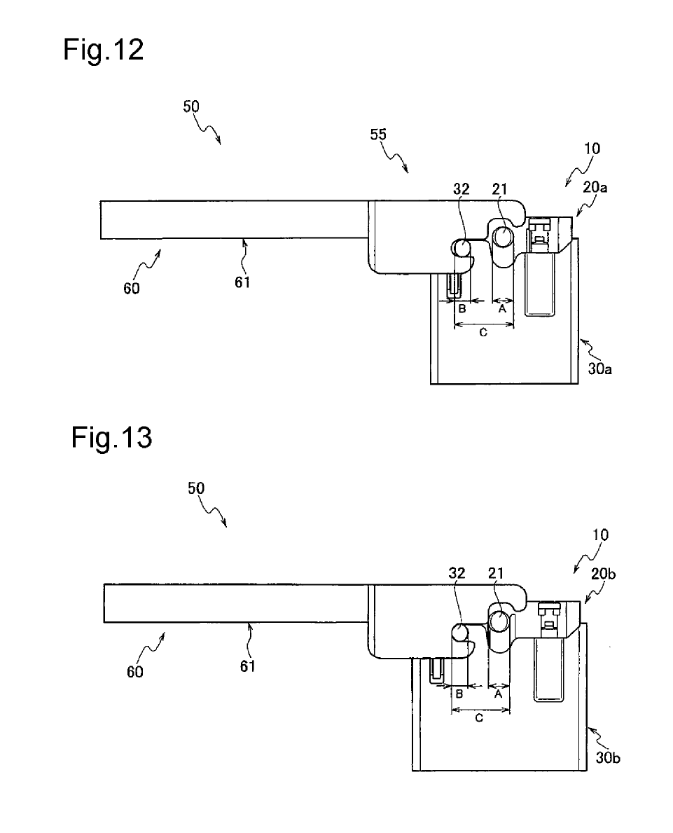

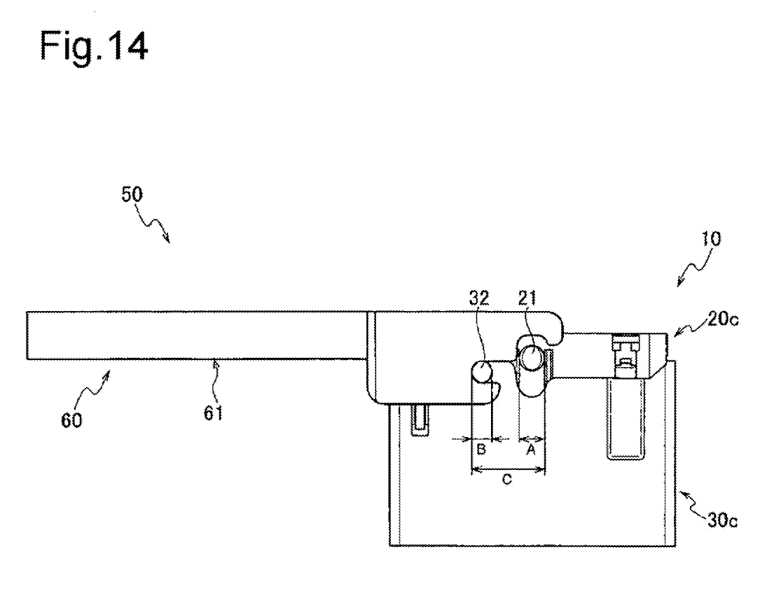

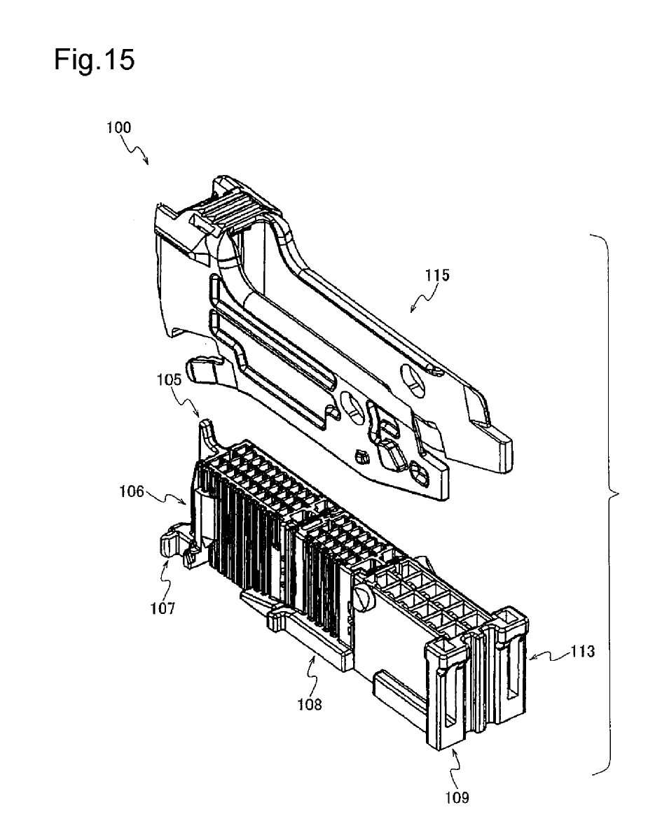

Hereinafter, a first embodiment of the invention will be described with reference to the accompanying drawings. FIG. 1A is an exploded perspective view illustrating an auxiliary fitting jig and a connector according to a first embodiment of the invention, and FIG. 1B is a perspective view illustrating the connector according to the first embodiment. FIG. 2 is a side view illustrating the auxiliary fitting jig according to the first embodiment of the invention. FIG. 3 is a diagram illustrating a temporary locking state of female and male connectors according to the first embodiment of the invention. FIG. 4 is a diagram illustrating a state where the auxiliary fitting jig is mounted on the female and male connectors according to the first embodiment of the invention. FIG. 5 is a diagram illustrating a process where the female and male connectors according to the first embodiment of the invention are fitted to each other. FIG. 6 is a diagram illustrating a state where the auxiliary fitting jig according to the first embodiment of the invention is rotated. FIG. 7 is a diagram illustrating a state where the female and male connectors according to the first embodiment of the invention are fitted to each other. FIG. 8 is a diagram illustrating a state where the auxiliary fitting jig according to the first embodiment of the invention is detached. FIG. 9 is a side view illustrating the female and male connectors according to the first embodiment of the invention. FIG. 10 is a cross-sectional view taken along line A-A in FIG. 9. FIG. 11 is a cross-sectional view taken along line B-B in FIG. 9. FIG. 12 is a diagram illustrating general usage of the auxiliary fitting jig according to the first embodiment of the invention. FIG. 13 is a diagram illustrating general usage of the auxiliary fitting jig according to the first embodiment of the invention. FIG. 14 is a diagram illustrating general usage of the auxiliary fitting jig according to the first embodiment of the invention. FIG. 15 is a diagram illustrating unnecessary components in a case where a lever of a lever type connector in the related art is removed.

Firstly, configurations of an auxiliary fitting jig and a connector according to the first embodiment of the invention will be described with reference to FIGS. 1A and 1B and FIG. 2.

As shown in FIGS. 1A and 1B, a connector 10 according to the first embodiment of the invention mainly includes a female connector 20 which accommodates a terminal (not shown) therein and a male connector 30 into which the female connector 20 is inserted and fitted. Further, by rotating an auxiliary fitting jig 50 (which will be described later), the female and male connectors 20 and 30 are fitted to each other using leverage.

The female connector 20 includes a connector body 24 which includes an action point protrusion 21 which protrudes on the outside of the female connector 20 and serves as an action point at the time of rotation of the auxiliary fitting jig 50, a temporary female locking protrusion 22 which protrudes on the outside of the female connector 20 and is locked in the male connector 30 when inserted to the male connector 20, and a temporary female locking stopper 23 which protrudes on the outside of the female connector 20 and retains the female and male connectors 20 and 30 in a temporary locking position by being in contact with a temporary male locking stopper of the male connector 30 (which will be described later).

The male connector 30 includes a connector housing 35 which includes a fitting hood 31 in which the female connector 20 is inserted, a supporting point protrusion 32 which protrudes on the outside of the male connector 30 and serves as a supporting point at the time of rotation of the auxiliary fitting jig 50, a temporary male locking protrusion 33 which protrudes on the inside of the male connector 30 and is overridden by the temporary female locking protrusion 22 when the female connector 20 is inserted; and a temporary male locking stopper 34 which retains the female and male connectors 20 and 30 in the temporary locking position by being in contact with the temporary female locking stopper 23. Further, a notch section 36 in which the action point protrusion 23 is inserted at the time of fitting of the female and male connectors 20 and 30, is formed in the connector housing 35.

A housing locking section 40 which locks the fitted state of the female and male connectors 20 and 30 is installed on a different side opposite to a side where the temporary female locking protrusion 22 and the temporary male locking protrusion 33 are installed, in the female and male connectors 20 and 30.

As shown in FIGS. 1A and 1B and FIG. 2, the auxiliary fitting jig 50 mainly includes a jig hooking section 55 which includes a jig locking section 51 which is engaged with the male connector 30 and a jig pushing section 52 which is engaged with the female connector 20, and a jig gripping section 60 which is integrally formed with the jig hooking section 55 and rotates the jig pushing section 52 by rotating the jig hooking section 55 using the jig locking section 51 as a supporting point to fit the female connector 20 to the male connector 30.

The jig locking section 51 has a supporting point engaging section 53 of a notch shape which is engaged with the supporting point protrusion 32 of the male connector 30 and serves as a supporting point when the female and male connectors 20 and 30 are fitted to each other. Further, the jig pushing section 52 has an action point engaging section 54 of a notch shaped concave portion which is engaged with the action point protrusion 21 of the female connector 20 and serves as an action point when the female and male connectors 20 and 30 are fitted to each other.

The jig hooking section 55 is formed in the shape of “U” by a pair of hooking plate sections 56 in which the jig locking section 51 and the jig pushing section 52 are respectively formed and a connecting plate section 57 which connects between the hooking sections 56, and the jig gripping section 60 is integrally connected with the connecting plate section 57. Further, the jig gripping section 60 includes a power point operating section 61 which serves as a power point for pushing downward the vicinity of the jig pushing section 52 at the time of rotation of the auxiliary fitting jig 50.

The auxiliary fitting jig 50 rotates the jig gripping section 60 using the supporting point locking section 53 as a supporting point, to fit the female and male connectors 20 and 30 using leverage. Accordingly, in the auxiliary fitting jig 50, the distance between the supporting point engaging section 53 and the action point engaging section 54 is shorter than the distance between the supporting point engaging section 53 and the power point operating section 61.

Next, a fitting operation of the female and male connectors 20 and 30 according to the first embodiment of the invention will be described with reference to FIGS. 1A to 11.

As shown in FIGS. 1A and 1B, if the female connector 20 is inserted in the male connector 30, as shown in FIGS. 9 to 11, the temporary female locking protrusion 22 overrides the temporary male locking protrusion 33 and the female locking stopper 23 and the temporary male locking stopper 34 are in contact with each other, to thereby retain the female and male connector 20 and 30 in the temporary locking position. By retaining the female and male connector 20 and 30 in the temporary locking position, it is easy to mount the auxiliary fitting jig 50.

Next, as shown in FIG. 3, after the female and male connector 20 and 30 are retained in the temporary locking position, the auxiliary fitting jig 50 is mounted by sliding the hocking plate sections 56 of the auxiliary fitting jig 50 on outer walls of the female and male connectors 20 and 30. Specifically, as shown in FIGS. 4 and 5, the supporting point engaging section 53 of the auxiliary fitting jig 50 is engaged with the supporting point protrusion 32 of the male connector 30 and the pushing action point engaging section 54 of the auxiliary fitting jig 50 is engaged with the action point protrusion 21 of the female connector 20.

Next, as shown in FIGS. 5 and 6, after the auxiliary fitting jig 50 is engaged with the female and male connectors 20 and 30, the power point operating section 61 of the auxiliary fitting jig 50 is rotated upward (in an F direction in FIGS. 5 and 6) to use leverage. Specifically, the action point engaging section 54 pushes the action point protrusion 21 of the female connector 20 downward, using the supporting point engaging section 53 of the auxiliary fitting jig 50 as a supporting point, to thereby fit the female connector 20 to the male connector 30. In this way, by rotating the jig gripping section 60, it is possible to easily fit the female and male connectors 20 and 30 to each other using leverage.

Further, as shown in FIG. 1B, the female and male connectors 20 and 30 has the housing locking section 40 on a different side opposite to a side where the auxiliary fitting jig 50 is mounted. The housing locking section 40 is installed in a position where the jig hooking section 55 is not in contact with the housing locking section 40 when the supporting point engaging section 53 of the auxiliary fitting jig 50 pushes the supporting point protrusion section 32 of the male connector 30 downward, and locks the fitted state of the female and male connectors 20 and 30.

Further, as shown in FIG. 8, after the female connector 20 is fitted to the male connector 30, the auxiliary fitting jig 50 is detached by sliding the hooking plate sections 56 of the auxiliary fitting jig 50 on the outer walls of the female and male connectors 20 and 30 auxiliary fitting jig, and then, the fitting operation of the female and male connectors 20 and 30 is completed. In this way, by detaching the auxiliary fitting jig 50, it is possible to reduce the weight of components of the connector 10.

Next, general usage of the auxiliary fitting jig 50 according to the first embodiment of the invention will be described with reference to FIGS. 12 to 14.

In the auxiliary fitting jig 50 according to the first embodiment of the invention, even in a case where the sizes of the female and male connectors 20 and 30 are different, it is possible to fit the female and male connector 20 and 30 to each other by the same auxiliary fitting jig 50. Specifically, as shown in FIGS. 12 to 14, female and male connectors 20a and 30a, female and male connectors 20b and 30b, and female and male connectors 20c and 30c have different sizes, respectively. However, in a case where the diameter A of the action point protrusions 21 of the female connectors 20a to 20c is constant, the diameter B of action point protrusions 32 of the male connectors 30a to 30c is constant, and the interval C between the action point protrusion 21 and the supporting point protrusion 32 is constant, even in a case where the sizes of the female and male connectors 20a to 20c and 30a to 30c are different, it is possible to fit the female and male connectors 20a to 20c and 30a to 30c to each other by the same auxiliary fitting jig 50. Accordingly, by fitting the female and male connectors 20 and 30 having a plurality of sizes using the auxiliary fitting jig 50 of one type, the auxiliary fitting jig 50 with high general usage and the female and male connectors 20 and 30 using the same are obtained.

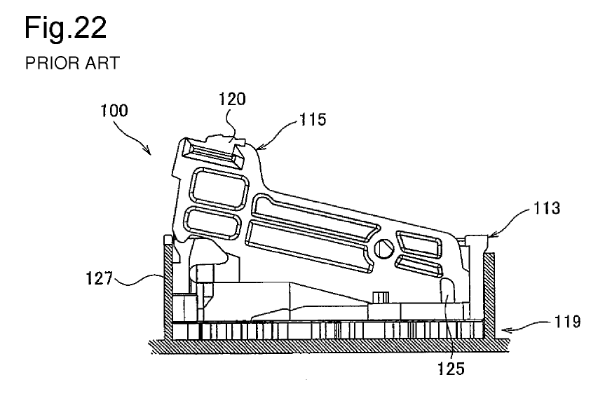

Next, effects of the female and male connectors using the auxiliary fitting jig according to the first embodiment of the invention will be described with reference to FIG. 15 and FIGS. 20 to 23.

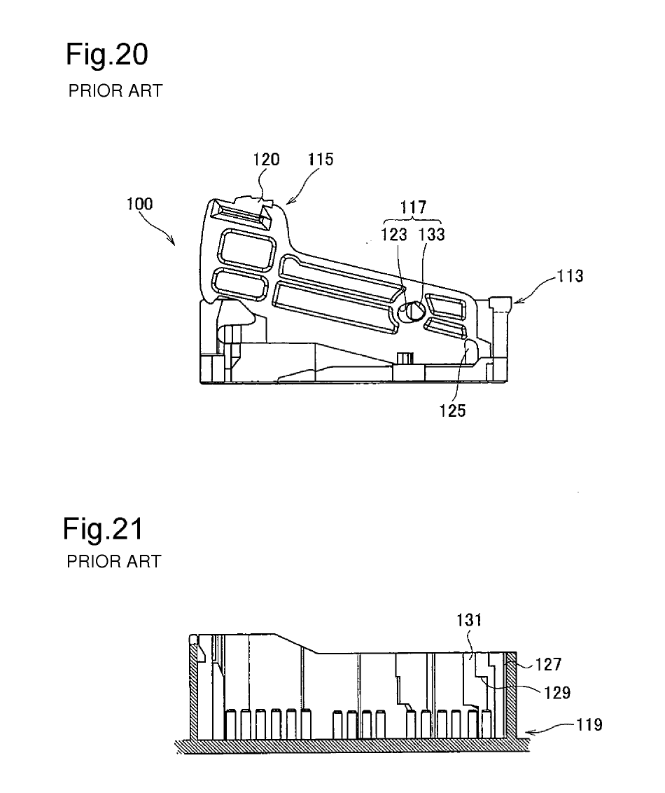

As shown in FIGS. 20 to 23, in the lever type connector 100 in the related art, the lever 115 is fitted to the female housing 119 to serve as a supporting point, and then, the lever 115 is pushed downward and is rotated to fit the male and female housings 113 and 119 to each other. Thus, as shown in FIG. 15, the lever type connector 100 should have a terminal connecting protrusion 105 which locks a plurality of terminals accommodated in the male housing 113; a temporary locking protrusion 106 for inclining upward the lever 115 between one side and the other side thereof in a length direction thereof in a normal state for temporary locking; a rib 107 which guides the male housing 113 to a guide groove (not shown) installed in the side of the female housing 119; a lever rotation prevention shape 108 which prevents the lever 115 from being rotated in a downward direction which is a front end side of a direction where the male housing 113 and the female housing 119 are fitted to each other; and a lever lift prevention shape 109 which prevents the lever 115 from being lifted upward after the male housing 113 and the female housing 119 are fitted to each other.

However, in the female and male connectors 20 and 30 using the auxiliary fitting jig 50 according to the first embodiment of the invention, as the auxiliary fitting jig 50 is engaged with the female and male connectors 20 and 30 and the power point operating section 61 of the auxiliary fitting jig 50 is then rotated upward, using the supporting point engaging section 53 of the auxiliary fitting jig 50 as a supporting point, since the action point engaging section 54 pushes the action point protrusion 21 of the female connector 20 downward and the female connector 20 is thus fitted to the male connector 30, it is possible to detach the auxiliary fitting jig 50 after fitting. Accordingly, compared with the lever type connector 100 in the related art, in the female and male connectors 20 and 30 using the auxiliary fitting jig 50 according to the first embodiment of the invention, the terminal connecting protrusion 105, the temporary locking protrusion 106, the rib 107, the lever rotation prevention shape 108, and the lever lift prevention shape 109 can be removed or improved.

In this way, the auxiliary fitting jig 50 which fits the female and male connectors 20 and 30 according to the first embodiment of the invention includes the jig hooking section 55 which includes the jig locking section 51 which is engaged with the male connector 30 and the jig pushing section 52 which is engaged with the female connector 20, and the jig gripping section 60 which is integrally formed with the jig hooking section 55 and rotates the jig pushing section 52 by rotating the jig hooking section 55 using the jig locking section 51 as the supporting point to fit the female connector 20 to the male connector 30. Thus, by detaching the auxiliary fitting jig 50 after the female and male connectors 20 and 30 are fitted to each other, it is possible to reduce the weight of components of the connector 10.

Further, since the auxiliary fitting jig 50 is detached after the female and male connectors 20 and 30 are fitted to each other, it is possible to remove components for locking the auxiliary fitting jig 50 after fitting.

Accordingly, compared with the lever type connector in the related art in which the lever is mounted after the female and male connectors are fitted to each other, it is possible to provide the auxiliary fitting jig 50 in which the number and weight of components can be decreased and manufacturing cost can be reduced, and the connector 10 using the auxiliary fitting jig 50.

Further, in the auxiliary fitting jig 50 according to the first embodiment of the invention, the jig hooking section 55 is formed in the shape of “U” by one pair of hooking plate sections 56 in which the jig locking section 51 and the jig pushing section 52 are respectively formed and the connecting plate section 57 which connects between the hooking sections 56, and the jig gripping section 60 is integrally connected with the connecting plate section 57. Thus, by rotating the jig gripping section 60 using the jig locking section 51 as a supporting point, it is possible to easily fit the female and male connectors 20 and 30 to each other using leverage.

Further, in the auxiliary fitting jig 50 according to the first embodiment of the invention, the jig locking section 51 is the supporting point engaging section 53 which is engaged with the supporting point protrusion 32 of the male connector 30, and the jig pushing section 52 is the action point engaging section 54 which is engaged with the action point protrusion 21 of the female connector 20. Thus, if the diameter of the supporting point protrusion 32 of the male connector 30 is constant and the diameter of the action point protrusion 21 of the female connector 20 is constant, and the interval between the supporting point protrusion 32 of the male connector 30 and the action point protrusion 21 of the female connector 20 is constant, even in a case where the female and male connectors 20 and 30 are different, it is possible to fit the female and male connectors 20 and 30 to each other by the same auxiliary fitting jig 50. Accordingly, it is possible to fit connectors 10 of a plurality of sizes to each other using the auxiliary fitting jig 50 of one type, to thereby provide the auxiliary fitting jig 50 with high general usage and the connector 10 using the same.

Further, in the connector 10 in which the female and male connectors 20 and 30 are fitted to each other using the auxiliary fitting jig 50 according to the first embodiment of the invention, the female and male connectors 20 and 30 are retained in the temporary locking position as the temporary female locking stopper 23 which protrudes on the outside of the female connector 20 is in contact with the temporary male locking stopper 34 which protrudes on the inside of the male connector 30. Thus, it is easy to mount the auxiliary fitting jig 50, and it is possible to easily fit the female and male connectors 20 and 30 to each other.

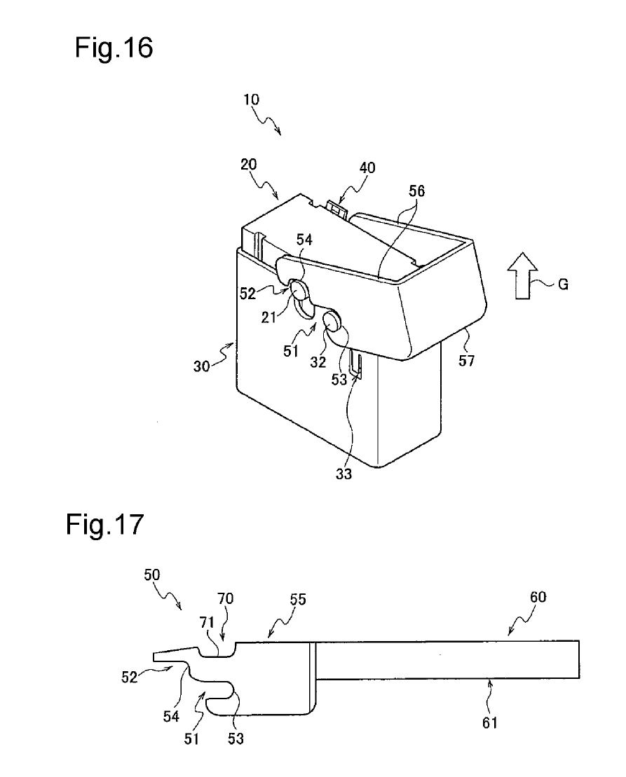

Next, a second embodiment of the invention will be described with reference to FIG. 16. FIG. 16 is a perspective view illustrating an auxiliary fitting jig and a connector according to the second embodiment of the invention.

Further, since the auxiliary fitting jig 50 and the connector 10 according to the second embodiment have approximately the same configuration or the like as the auxiliary fitting jig 50 and the connector 10 according to the first embodiment, description to the same configuration will be omitted. Further, components corresponding to the auxiliary fitting jig 50 and the connector 10 will be given the same reference numerals for description.

As shown in FIG. 16, the jig hooking section 55 of the auxiliary fitting jig 50 according to the second embodiment of the invention is formed in a “U” shape by the pair of hooking plate sections 56 in which the jig locking section 51 and the jig pushing section 52 are respectively formed and the connecting plate section 57 which connects between the hooking sections 56. Thus, by rotating upward (in a G direction in FIG. 16) the connecting plate section 57 of the auxiliary fitting jig 50 using the jig locking section 51 to use leverage. Specifically, the action point engaging section 54 pushes the action point protrusion 21 of the female connector 20 downward, using the supporting point engaging section 53 of the auxiliary fitting jig 50 as a supporting point, to fit the female connector 20 to the male connector 30. In this way, since the female and male connectors 20 and 30 can be easily fitted to each other using leverage by rotating upward the connecting plate section 57, it is possible to remove the jig gripping section 60.

In this way, in the auxiliary fitting jig 50 according to the second embodiment of the invention, by removing the power point operating section 61 of the auxiliary fitting jig 50, it is possible to further reduce the number and weight of components compared with the auxiliary fitting jig 50 and the connector 10 according to the above-described first embodiment.

Further, in a case where the jig gripping section 60 is removed, since the connecting plate section 57 serves as a power point, the distance between the supporting point engaging section 53 and the connecting plate section 57 is set to be longer than the distance between the supporting point engaging section 53 and the action point engaging section 54, and thus, it is possible to easily fit the female and male connectors 20 and 30 to each other.

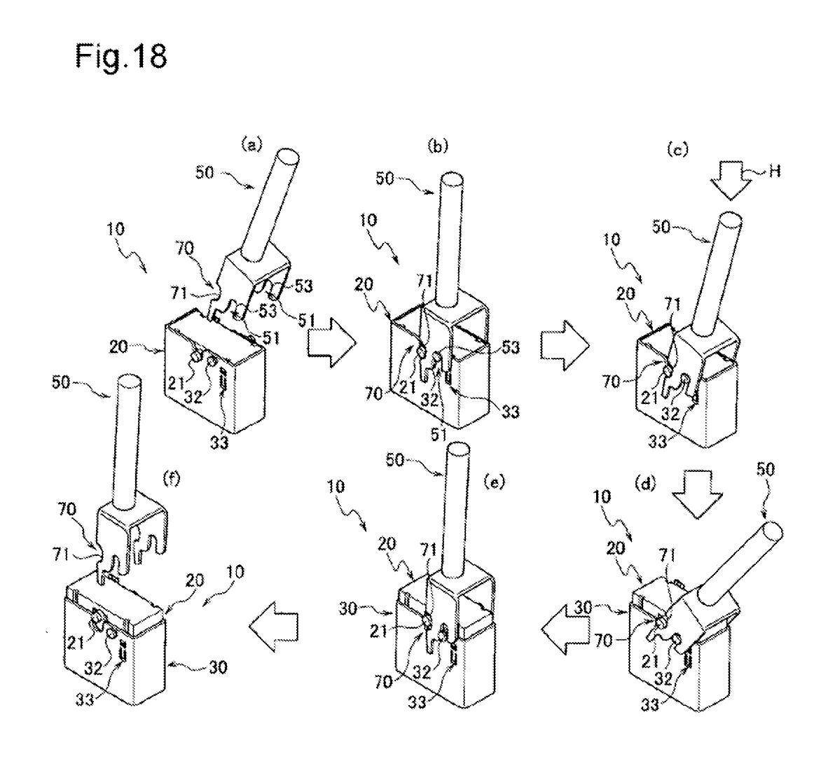

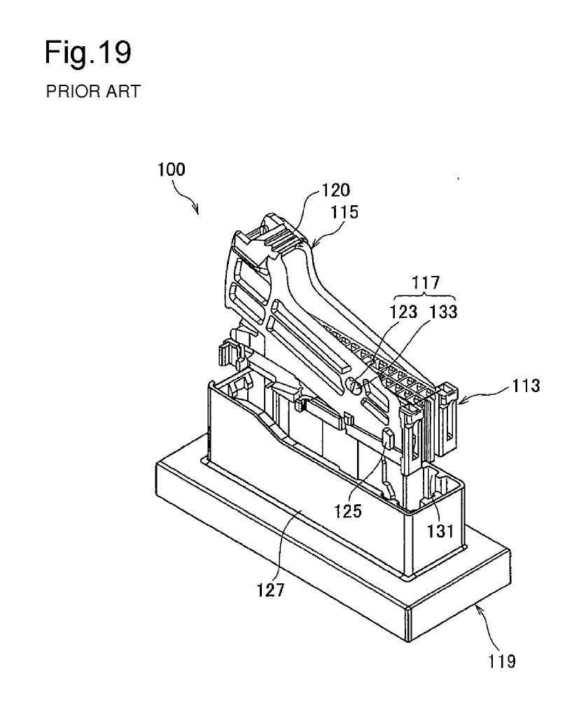

Next, a third embodiment of the invention will be described with reference to FIG. 17 and FIGS. 18A to 18F. FIG. 17 and FIGS. 18A to 18F show the third embodiment of the invention, in which FIG. 17 is a side view illustrating an auxiliary fitting jig according to the third embodiment of the invention, and FIGS. 18A to 18F are diagrams illustrating fitting and detaching operations of a connector according to a third embodiment of the invention.

Since the auxiliary fitting jig and the connector according to the third embodiment of the invention have approximately the same configurations of the auxiliary fitting jig 50 and the connector 10 according to the first embodiment, description will be omitted with respect to the same configurations. Further, the same reference numerals are given to the components corresponding to the auxiliary fitting jig 50 and the connector 10 for description.

Firstly, the auxiliary fitting jig according to the third embodiment of the invention will be described with reference to FIG. 17.

As shown in FIG. 17, the auxiliary fitting jig 50 includes the jig hooking section 55 which includes the jig locking section 51 which is engaged with the male connector 30 and the jig pushing section 52 which is engaged with the female connector 20; and the jig gripping section 60 which is integrally formed with the jig hooking section 55 and rotates the jig pushing section 52 by rotating the jig hooking section 55 using the jig locking section 51 as a supporting point to fit the female connector 20 to the male connector 30.

The jig locking section 51 has the supporting point engaging section 53 of a notch shape which is engaged with the supporting point protrusion 32 of the male connector 30. Further, the jig pushing section 52 has the pushing action point engaging section 54 which is engaged with the action point protrusion 21 of the female connector 20.

Further, the jig hooking section 55 of the auxiliary fitting jig 50 according to the third embodiment of the invention includes a jig extracting section 70 which is engaged with one of the female and male connectors 20 and 30 in a fitted state and extracts the female and male connectors 20 and 30 from each other by rotating the jig hooking section 55 using the jig locking section 51 as a supporting point. The jig extracting section 70 includes an extracting action point engaging section 71 which includes a concave portion of a notch shape which is engaged with the action point protrusion 21 of the female connector 20.

Next, a detaching operation of the female and male connectors 20 and 30 according to the third embodiment of the invention will be described with reference to FIGS. 18A to 18F.

As shown in FIG. 18A, the auxiliary fitting jig 50 is mounted by sliding on the outer walls of the fitted female and male connectors 20 and 30. Specifically, as shown in FIG. 18B, the supporting point engaging section 53 of the auxiliary fitting jig 50 is engaged with the supporting point protrusion section 32 of the male connector 30, and the extracting action point engaging section 71 of the auxiliary fitting jig 50 is engaged with the action point protrusion 21 of the female connector 20.

Next, as shown in FIGS. 18C and 18E, after the auxiliary fitting jig 50 is engaged with the female and male connectors 20 and 30, by rotating the power point operating section 61 of the auxiliary fitting jig 50 downward (in an H direction in FIG. 18C), the extracting action point engaging section 71 of the auxiliary fitting jig 50 pushes the action point protrusion 21 of the female connector 20 upward, to thereby detach the female connector 20 from the male connector 30.

Then, as shown in FIG. 18F, after the female connector 20 is detached from the male connector 30, the auxiliary fitting jig 50 is detached by sliding the hooking plate sections 56 of the auxiliary fitting jig 50 on the outer walls of the female and male connectors 20 and 30, and then, the detaching operation of the female and male connectors 20 and 30 is completed.

In this way, the jig hooking section 55 of the auxiliary fitting jig 50 according to the third embodiment of the invention is provided with the jig extracting section 70 which extracts the female connector 20 from the male connector by rotating the jig hooking section 55 in a reverse direction compared with the time when the female and male connectors 20 and 30 are fitted to each other using the jig locking section 51 as the supporting point. Thus, it is possible to fit and detach the connector 10 using one type of the auxiliary fitting jig 50. Further, since it is not necessary to create an auxiliary fitting jig for fitting and an auxiliary fitting jig for detachment, it is possible to reduce manufacturing cost.

Hereinbefore, the auxiliary fitting jig and the connector using the same have been described on the basis of the embodiments, but the invention is not limited thereto. That is, the configuration of each section may be replaced with an arbitrary configuration having the same function.

The invention is not limited to the above-described embodiments, but may be appropriately modified or improved. Further, in the above-described embodiments, materials, shapes, dimensions, values, types, numbers, arranged positions and the like are not limiting, but arbitrary as long as they can achieve the invention.

Although the invention has been described in detail with reference to the specific embodiments, it is obvious to those skilled in the art that a variety of modifications or improvements can be made without departing from the spirit and scope of the invention.

This application is based on Japanese Patent Application No. 2010-012312, filed Jan. 22, 2010, the content of which is incorporated herein by reference.

### INDUSTRIAL APPLICABILITY

The invention is very useful for reducing the number and weight of components and manufacturing cost when connectors are fitted to each other.

### REFERENCE SIGNS LIST

10: CONNECTOR
20: FEMALE CONNECTOR
21: ACTION POINT PROTRUSION
22: TEMPORARY FEMALE LOCKING PROTRUSION
23: TEMPORARY FEMALE LOCKING STOPPER
24: CONNECTOR BODY
30: MALE CONNECTOR
31: FITTING HOOD
32: SUPPORTING POINT PROTRUSION
33: TEMPORARY MALE LOCKING PROTRUSION
34: TEMPORARY MALE LOCKING STOPPER
35: CONNECTOR HOUSING
36: NOTCH SECTION
40: HOUSING LOCKING SECTION
50: AUXILIARY FITTING JIG
52: JIG PUSHING SECTION
53: SUPPORTING POINT ENGAGING SECTION
54: PUSHING ACTION POINT ENGAGING SECTION
55: JIG HOOKING SECTION
56: HOOKING PLATE SECTION
57: CONNECTING PLATE SECTION
60: JIG GRIPPING SECTION
61: POWER POINT OPERATING SECTION
70: JIG EXTRACTING SECTION
71: EXTRACTING ACTION POINT ENGAGING SECTION

1. A system comprising:
a female connector;
a male connector; and
an auxiliary fitting jig which fits the female connector and the male connector to each other, including: a jig hooking section which includes a jig locking section which is engaged with one of the female and male connectors and a jig pushing section which is engaged with the other of the female and male connectors; and a jig gripping section which is integrally formed with the jig hooking section, rotates the jig pushing section by rotating the jig hooking section using the jig locking section as a supporting point, and fits the other connector to the one connector,
wherein the action point protrusion, a temporary female locking protrusion which protrudes on the outside of the female connector and locks the female connector when being inserted into the male connector and a temporary female locking stopper which protrudes on the outside of the female connector and retains the female connector in a temporary locking position are provided in the female connector; and
the supporting point protrusion, a temporary male locking protrusion which protrudes on the inside of the male connector and is overridden by the temporary female locking protrusion when the female connector is inserted and a temporary male locking stopper which protrudes on the inside of the male connector and retains the female and male connectors in the temporary locking position by being in contact with the temporary female locking stopper are provided in the male connector.

2. The system according to claim 1, wherein the jig locking section comprises a supporting point engaging section comprising a first notch which is engaged with a supporting point protrusion of the one of the female connector and male connector, and
wherein the jig pushing section comprises an action point engaging section comprising a second notch which is engaged with an action point protrusion of the other one of the female connector and male connector.

3. The system according to claim 1, wherein the jig hooking section comprises a jig extracting section, separate and distinct from the jig locking section and the jig pushing section, engaged with the one of the female connector and male connector in a fitted state and configured to extract the one connector from the other connector by rotating the jig hooking section in a reverse direction, opposite from the first direction.

4. The system according to claim 1, wherein the first and second notches extend in a direction perpendicular from each other.
